(19) United States
(12) Patent Application Publication
(10) Pub. No.: US 2026/0030074 A1
(43) Pub. Date: Jan. 29, 2026

(54) NON-BLOCKING AND EVENTUALLY CONSISTENT HASHING

(71) Applicant: Oracle International Corporation, Redwood Shores, CA (US)

(72) Inventors: Rajesh Desai, Sunnyvale, CA (US); Shubhajit Bhattacharya, Bengaluru (IN); Prakash Chandra Kumar, Bangaluru (IN)

(73) Assignee: Oracle International Corporation, Redwood Shores, CA (US)

(21) Appl. No.: 18/781,884

(22) Filed: Jul. 23, 2024

(51) Int. Cl. G06F 9/50; G06F 16/22

(52) U.S. Cl. CPC G06F 9/5083; G06F 16/2255

(57) ABSTRACT

Techniques are described for enabling uninterrupted services by computing resources on nodes of a consistency hash ring (CHR) while adding or removing nodes (i.e., making changes) of the CHR. In some embodiments, a duplicate of the existing CHR (i.e., old version) is created to become a new version for performing the changes. Two versions of consistent hash rings (CHRs) co-exist during the transition period of making changes. In some embodiments, computing resources on the nodes of these CHRs perform version upgrades and data migration while continuing to service client requests without interruption.

### FIELD

The present disclosure generally relates to consistent hashing. More specifically, but not by way of limitation, techniques are described for enabling uninterrupted services by computing resources on nodes of a consistency hash ring while adding or removing nodes of the consistency hash ring, and maintaining consistency after the changes to the nodes are complete.

### BACKGROUND

Consistent hashing is a useful technique that contributes to the stability, scalability, and efficiency of distributed systems. However, limitations of such a technique still exist.

### BRIEF SUMMARY

The present disclosure generally relates to consistent hashing. More specifically, but not by way of limitation, techniques are described for enabling uninterrupted services by computing resources on nodes of a consistency hash ring while adding or removing nodes of the consistency hash ring, and maintaining consistency after the changes to the nodes are complete.

One general aspect includes a method performed by one or more processors of a first mobile device. The method also includes creating a first consistent hash ring (CHR) and a second consistent hash ring, the first CHR being associated with a first version number, the second CHR being associated with a second version number. The method also includes associating a first compute resource with the first CHR by linking the first version number to the first compute resource. The method also includes associating a second compute resource with the second CHR by linking the second version number to the second compute resource. The method also includes migrating data associated with the first compute resource in the first CHR to the second compute resource in the second CHR, the data comprising a plurality of objects. The method also includes receiving, by one of the first compute resource and the second compute resource, a request for accessing a first object of the plurality of objects of the data being migrated from the first compute resource in the first CHR to the second compute resource in the second CHR. The method also includes providing, by the second compute resource, the first object of the plurality of objects of the data after the first object is migrated from the first compute resource to the second compute resource.

In various embodiments, a system is provided that includes one or more data processors and a non-transitory computer readable medium containing instructions which, when executed on the one or more data processors, cause the one or more data processors to perform part or all of one or more methods disclosed herein.

In various embodiments, a non-transitory computer-readable medium, storing computer-executable instructions which, when executed by one or more processors, cause the one or more processors of a computer system to perform one or more methods disclosed herein.

In various embodiments, a computer-program product, comprising computer program/instructions which, when executed by a processor, cause the processor to perform any of the methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1A is a simplified diagram illustrating an environment in which a consistent hash ring (CHR) is used by a service system for servicing clients, according to some embodiments.

FIG. 1B is a simplified diagram illustrating an environment in which a consistent hash ring (CHR) is used by a service system for servicing clients, according to some embodiments.

FIG. 2 is a simplified diagram illustrating an architecture implementing a non-block consistency hashing, according to some embodiments.

FIG. 3 is a flowchart illustrating a method for performing non-blocking and eventually consistent hashing, according to certain embodiments.

FIG. 4 is a flowchart illustrating a method for fulfilling a request from a client associated with a version-1 CHR, according to certain embodiments.

FIG. 5 is a flowchart illustrating a method for fulfilling a request from a client associated with a version-2 CHR, according to certain embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Scalable systems distribute incoming requests across servers using a data structure called a consistent hash table (CHT). CHT may allow changes (e.g., adding or removing) to one or more servers without requiring a lot of data movement. However, CHT requires a pause in the incoming request processing while all the front-end load balancers and the back-end servers are updated with the new hash table. This disruption to client request traffic could be significant when there is a large number of servers that need to be updated. Thus, there is a need to address these challenges and others.

### I. Non-Blocking and Eventually Consistent Hashing

A consistent hash table may be formed as a circular table, also referred to as a consistent hash ring (CHR). The CHR may have multiple cells, where each cell (also referred to as a compute resource), a node on the CHR, may be a logical partition of a group of servers that can process and/or fulfill client requests. Compute resources may be infrastructure resources that provide processing capabilities in the cloud. A hash function may be used to map particular data to a cell (i.e., to be stored in a storage associated with a server in the cell) on the hash ring.

The techniques called non-blocking and eventually consistent hashing (also referred to as on-demand refresh) described herein enable uninterrupted services (e.g., processing incoming requests from clients without any interruption) by compute resources (e.g., servers of cells) on nodes of a consistency hash ring while making changes to the nodes (e.g., adding or removing the nodes) of the consistency hash ring. The techniques are non-blocking because the changes to the node of CHR do not block the services. The consistency and integrity of data are maintained after the changes are complete.

In some embodiments, a duplicate of the existing CHR (i.e., old version) is created to become a new version CHR for performing the changes. The techniques utilize two co-existing versions (an old version and a new version) of CHRs during the transition period of making changes to the nodes of a CHR. During the transition period, cells/servers and clients are updated (or upgraded) from the old version CHR (referred to as v1-ring) to the new version of CHR referred to as v2-ring). Data (called object or data object with a ring version in its metadata) is also migrated from the v1-ring to the v2-ring. Once the update/upgrade and data migration are completed, the v1-ring (i.e., the old version CHR), including its associated cells/servers may be removed. Services to clients are uninterrupted during the transition period by using various protocols to complete the version update/upgrade and data migration. In other words, the process of the version upgrade and data migration between v1-ring and v2-ring cells and their associated servers and the processing of servicing client's requests can be performed in parallel.

In some embodiments, a compute resource (CR)-CR message-passing protocol can enable a server of a cell associated with v2-ring to communicate with a corresponding server of a cell associated with v1-ring to migrate data stored in storage associated with the v1-ring to storage associated with the v2-ring. In some embodiments, a client-server ring-version update protocol can enable a client and a server of a cell that have different ring versions to upgrade the one with a lower version to a higher version upon communicating with each other. In some embodiments, a data-checking protocol can enable a server of a cell associated with v2-ring to communicate with a corresponding server of a cell associated with v1-ring to look up client's requested data during the data migration process.

Furthermore, in some embodiments, a client associated with a v1-ring may request data from a server of a cell associated with either a v1-ring or a v2-ring. Conversely, a client associated with a v2-ring may also request data from a server of a cell associated with either a v1-ring or a v2-ring. The disclosed techniques can handle different scenarios of these service requests while the version upgrade and data migration are in progress. The requesting client can eventually receive the requested data from a server of a cell associated with a v2-ring.

Embodiments of the present disclosure provide a number of advantages/benefits. For example, the disclosed techniques that enable uninterrupted services by compute resources while performing consistency hash ring upgrade between different versions significantly improve performance and provide better customer services. Additionally, because each server of a cell performs version upgrade and data migration processes at its own pace, servers and cells associated with different versions of CHRs are in different transition states. The disclosed protocols and client-server communication techniques allow the whole servicing system to handle these complicated situations gracefully and achieve eventual consistency.

### A. Clients, Cells, Servers, and Consistent Hash Ring

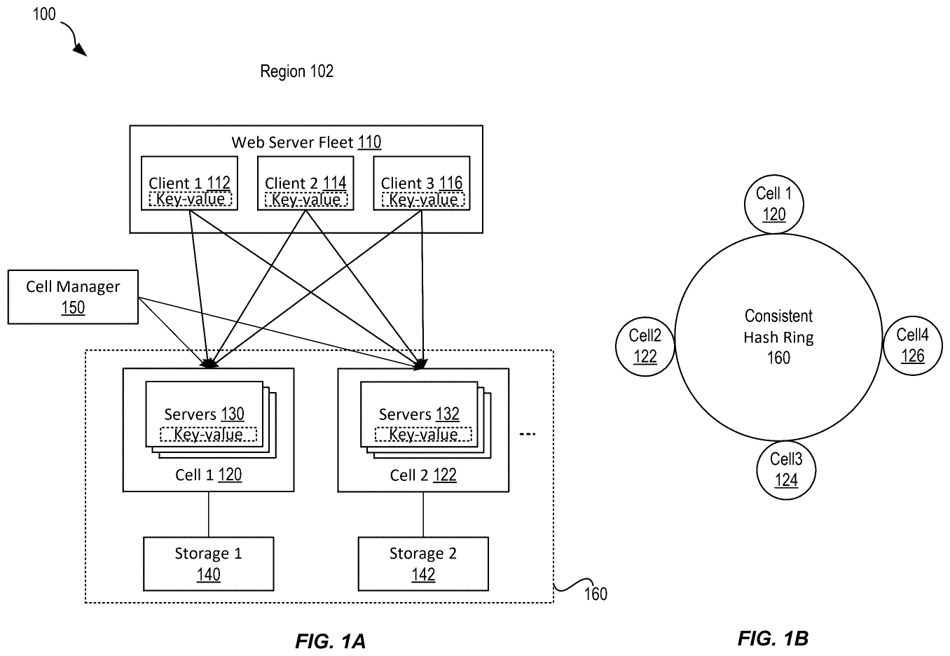

FIGS. 1A and 1B are simplified diagrams illustrating an environment in which a consistent hash ring (CHR) may be used by a service system for servicing clients, according to some embodiments. FIG. 1A illustrates a client-server communication architecture, according to some embodiments. FIG. 1B is a consistent hash ring with multiple cells on its nodes, according to some embodiments.

A region may have one or more data centers. Each data center may include infrastructure resources, such as compute, storage, and networking resources, that a cloud service provider (CSP) provides. Within a region, the data centers in the region may be organized into one or more availability domains (ADs). Availability domains are isolated from each other, fault-tolerant, and very unlikely to fail simultaneously. ADs are configured such that a failure at one AD within a region is unlikely to impact the availability of the other ADs within the same region. A realm refers to a logical collection of one or more regions. A realm can include one or more regions. Realms are typically isolated from each other and do not share data.

Distributed environment 100 depicted in FIGS. 1A & 1B is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In FIG. 1A, a region 102 may include multiple cells, cell 1 120, cell 2 122, etc. Each cell (e.g., cell 1 120) may be a logical partition of a group of servers (e.g., 130, such as metadata server) comprising physical computing resources (e.g., processors/cores, memory resources, and network resources) connected to storage (e.g., 140) storing data (also referred to as objects or data objects) for the group of servers.

A region may also have clients, such as multiple instances of web servers that may be formed as a fleet 110, including clients 112-116. A web server may service requests, such as creating, obtaining, or deleting objects (or data objects), from customers of the CSP. The web server, in turn, communicates the requests to servers, and becomes a client (e.g., client 1 112) of the servers (e.g., 130) in a cell (e.g., 120).

Referring to FIG. 1B, a CHR may include multiple cells (or nodes or members), such as cell 1 120-cell 4 126. In some embodiments, one region (e.g., 102) may contain a CHR 160, one version at a time, but more than one version may co-exist during a transition period for data migration (discussed below). The CHR may contain information about all the cells in that region. In some embodiments, the servers (e.g., 130) in a cell (e.g., 120) may share a key-value database (KVDB) that stores the CHR-related information, such as a particular ring version number (abbreviated as version number) for a CHR (e.g., 160). A storage (e.g., 140 of FIG. 1A) associated with and storing data objects for a particular cell (e.g., 120) may also store the ring version number in the metadata of each data object. The metadata may be initialized with the ring version number when the data is stored in a storage associated with a particular CHR. Thus, each cell and its corresponding servers, and data object may be associated with (or linked to) a particular version of CHR (e.g., 160) by storing a ring-version number in their respective key-value entries of KVDB and metadata.

Similarly, in some embodiments, each client may also keep a ring-version number of the CHR in its memory (e.g., cache or other storage such as database), such that the client can find the location where its requesting data objects may reside. In other words, each client is associated with or linked to a particular ring-version number. For example, in FIG. 1A, a client (e.g., 112) may send a request that contains a unique hashed fully-qualified object name (FQON, a complete path or address of a data object) to a particular CHR (160) based on the ring-version number. The resulting hash key may be within a particular range associated with a cell (e.g., 120) on the CHR. Thus, the client's request can be directed to a destination server (e.g., 130) in the cell, for example, by looking up DNS to find endpoints of servers in the cell, to access (e.g., read or write) the requested data objects in a storage (e.g., 140).

In some embodiments, a cell manager 150 may be responsible for setting up the cells in a region by associating these cells with a CHR, such as updating the ring-version numbers in the KVDB of the cells.

### B. Version Upgrade and Data Migration Between Two Versions of Consistent Hash Rings

When a cell is added or removed in a region, a new version of CHR (i.e., v2-ring) may be created. Accordingly, multiple versions of CHR may exist during the transitioning period of upgrading existing cells from their existing associated CHR (i.e., old version or v1-ring) to the new CHR (i.e., v2-ring). Once all cells and their corresponding servers have been upgraded and data has been migrated to the new CHR, the old CHR may be removed, including its associated cells and resources.

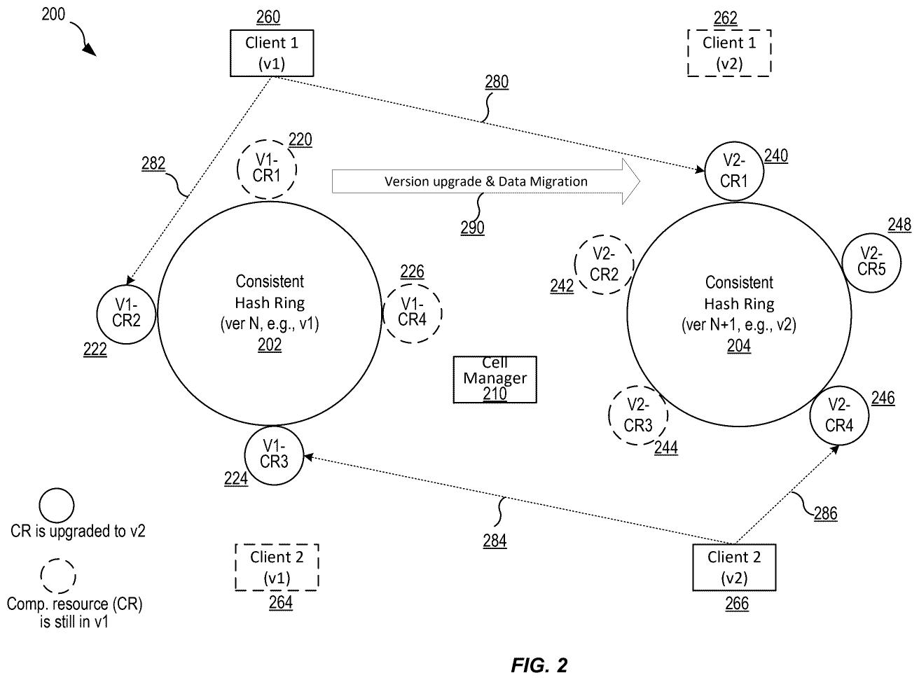

FIG. 2 is a simplified diagram illustrating an architecture implementing a non-block consistency hashing, according to some embodiments. Distributed environment 200 depicted in FIG. 2 is merely an example and is not intended to unduly limit the scope of claimed embodiments. Many variations, alternatives, and modifications are possible. For example, in some implementations, distributed environment 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

Before a customer of the CSP makes a request to add or remove cells, CHR 160 of FIG. 1B may be the same as CHR 202 of FIG. 2. In FIG. 2, when the customer makes a request to the cell manager 210 to add or remove a cell, for example, adding cell 5 (v2-CR5 or compute resource (CR) for v2-ring) 248, the cell manager may create a copy of CHR 202 (referred to herein as a duplicate CHR 202), including the cells and their servers, and try to upgrade the duplicate CHR 202 to become CHR 204 by changing all ring-version numbers in the KVDB of cells/servers, and metadata of their associated data. The clients (e.g., web servers 112-116 of FIG. 1A) in the region may also be informed by updating the ring-version numbers in their memory. Accordingly, as shown in FIG. 2, two versions of CHRs, v1-ring 202 and v2-ring 204, may co-exist during the transition period of updating the ring-version number from v1 to v2.

After the cell manager 210 creates the duplicate v1-ring with the duplicate cells and the new cell 5 (v2-CR5) 248, the cell manager may broadcast a message to all servers associated with the duplicate cells, and front-end load balancers. Since the cells are merely logical partitions, the underlying physical compute resources may need to be upgraded to the v2-ring by updating their ring-version numbers. This upgrade process may take a long time if there are a large number of servers. Thus, the CSP may not be able to afford such a long wait time without servicing its customers.

The upgrade process, covering cell/servers and client upgrade, and data migration, during the transition period, as discussed above, may be divided into many sub-processes. In the following discussion, a client associated with a v1-ring 202 and v2-ring 204 is referred to herein as v1-client (e.g., client 1 for v1 260) and v2-client (e.g., client 1 for v2 262), respectively. A cell/server associated with a v1-ring and v2-ring is referred to herein as v1-compute resource (v1-CR1 220, e.g., cell/server 1 for v1) and v2-compute resource (v2-CR1 240, e.g., cell/server 1 for v2), respectively. Thus, the sub-processes may include, but not limited to, (1) CR-CR communication to upgrade v1-CR to v2-CR, and migrating data from v1-CR to its corresponding v2-CR; and (2) client-server communication for requesting data. The client-server communication may further involve (a) a v1-client requesting data from a v1-CR; (b) a v1-client requesting data from a v2-CR; (c) a v2-client requesting data from a v1-CR; and (d) a v2-client requesting data from a v2-CR.

### 1. Compute Resource (CR)—CR Communication and Data Migration

In some embodiments, each pair of servers in a cell, the v1-compute resource (abbreviated as v1-CR) and v2-CR, may upgrade their ring-version number and migrate their associated data independently of another pair of servers in the same cell or a different cell and in parallel. Because there may be a large number of servers, servers may receive the broadcast message (or notification) from the cell manager at different times to start their upgrades. Thus, each pair of servers may perform its upgrade process at its own pace (e.g., start or end at a different time from another pair of servers in the same cell or a different cell), and has no dependency on another pair. For example, in FIG. 2, v1-CR1 220 may work with v2-CR1 240 to perform the upgrade process. If the upgrade and data migration processes are completed, v2-CR1 240 is denoted as a solid circle, and v1-CR1 220 is denoted as a dashed circle, meaning v1-CR1 220 is removed. As another example, v1-CR2 222 may work with v2-CR2 242 to perform the upgrade and data migration processes in parallel to the CR1 pairs (220 and 240). If the upgrade and data migration processes for CR2 pairs have not been completed, v1-CR2 222 is denoted as a solid circle, and v2-CR2 242 is denoted as a dashed circle.

When a duplicate cell/server (referred to as duplicate compute resource (CR)) receives the message from the cell manager 210 indicating a v2-ring has been created, the duplicate CR (e.g., duplicate v1-CR1 240) may update the ring version number in its KVDB to a higher version (e.g., from ring version N to ring version N+1). Once the ring version number has been updated, the duplicate CR may officially become v2-CR1 240. Then, v2-CR1 240 may communicate with v1-CR1 220 using a CR-CR message-passing protocol to start the data migration process 290.

Using the CR-CR message-passing protocol, the v2-CR1 240 may go through all its data objects (e.g., a list of object names in its KVDB) to identify which one should be migrated (i.e., not a new data object that is stored in its storage after v2-ring has been created), and communicate with its corresponding CR (i.e., v1-CR1 220) to migrate the identified data objects still residing on v1-ring. In the process of migrating the identified data objects, v1-CR1 220 can compute the hash, update the metadata of the data objects with the new ring version (e.g., v2), copy the identified data objects to the storage associated with v2-CR1 240, and delete the old data objects afterward. This data migration process may be referred to as re-sharding. Once the metadata of a particular data object (or data) has been updated with the v2-ring version (i.e., data migration has started), no other cells/servers can access that data object until it has been migrated to ensure consistency in the system during the migration.

This data migration process continues for all servers of a cell. Once all data objects have been moved from the servers of a cell associated with v1-ring (i.e., v1-CR1) to the servers of the corresponding cell associated with v2-ring (i.e., v2-CR1), v1-CR1 and its associated data may be deleted. This may complete the transition period for CR1 pair (i.e., v1-CR1 and v2-CR1). When all cells associated with the v2-ring complete the upgrade process, including data migration, the v1-ring is deleted, leaving only one CHR (i.e., v2-ring) for the region.

### 2. Client-Server Communication

As discussed above, clients may communicate with servers to request data during the upgrade process (including data migration), when two versions of CHR co-exist. A v1-client (also referred to herein as requester), who is still associated with the v1-ring may request data from either a v1-CR or a v2-CR, depending on whether the client is aware of the existence of v2-ring. In some embodiments, a front-end load balancer may exist to route the request. A client request may be routed to a v1-CR if the front-end load balancer is still associated with the v1-ring. Otherwise, the client request may be routed to a v2-CR.

Whenever a client communicates with a CR, the client's request may contain a ring version. Both the client and the receiving CR (e.g., a server in a cell) may update their ring version through a client-server ring-version update protocol. For example, the receiving server may compare the ring version from the request with the latest ring version stored in KVDB of its cell. If the requesting client has a lower-ring version (e.g., v1-client) than that (e.g., v2) of the receiving server, the server may send the new ring data and version to the client, which can update its memory (e.g., cache) with the latest ring data and version. If the receiving server has a lower ring version (e.g., v1) than that of the client (v2-client), but the cell the receiving server belongs to has v2, the receiving server may update its cache to v2. If the cell associated with the receiving server still has v1, but the requesting client is a v2-client, the cell may request the client to provide the new ring information. Thus, clients and CRs (cells and associated servers) can upgrade their ring versions through mutual communications.

Continuing with FIG. 2, when a v1-client (e.g., client 1 260) requests data (via communication 282) from a v1-CR (e.g., v1-CR2 222) that is not aware of v2-ring or has not received a broadcast message (or notification) from the cell manager, the v1-client may obtain the requested data from the v1-CR if the data is available. Once a v1-CR receives the notification from the cell manager or has communicated with a v2-client in the past, v1-CR may be upgraded to v2-CR. The communication between a v1-client and v2-CR is described below in more detail.

When a v1-client (e.g., client 1 260) requests data (via communication 280) from a v2-CR (e.g., v2-CR1 240), client 1 260 may update its ring version according to the client-server ring-version update protocol discussed above. Now, v1-client (e.g., client 1 260) may become a v2-client (e.g., client 1 262). Additionally, v2-CR1 240 may check whether the requested data has been migrated. If the requested data object is available (e.g., it has been migrated), v2-CR1 240 can respond to the client with the requested data object. If the requested data object is not available, this unavailability may have two situations: (1) the requested data object has not been migrated from v1-ring yet, or (2) the requested data object is a new data object that does not exist (i.e., neither in v1-ring or v2-ring). The v2-CR1 240 may communicate with the v1-CR1 220 using a data-checking protocol to find the requested data.

For example, the data-checking protocol for a v2-CR (e.g., v2-CR1 240) that is still performing data migration may involve the following process. In FIG. 2, a request for a data object from client 1 260 may include an object name. The receiving v2-CR1 240 that is still performing data migration from v1-CR1 220 may use the object name to look up its KVDB. If the object name does not match any data in the database, v2-CR1 240 may send a request with the object name to v1-CR1 220 to check the availability in the KVDB associated with v1-ring. If v1-CR1 220 cannot locate the requested object, a response is sent by v1-CR1 220 to v2-CR1 240, which in turn responds to the client about the unavailability of the requested data.

If v1-CR1 220 finds (or identifies) the requested object, it can then prepare the data migration of the requested data, as discussed above in relation to CR-CR message-passing protocol. Once the requested data has been migrated, v2-CR1 240 can respond to the newly upgraded client 1 262. In some embodiments, the requested data object may be migrated first. Once the metadata of that identified or requested data has been updated with the v2 ring version, no other cells/servers can access it until that requested data has been migrated to ensure consistency in the system during the migration. On the other hand, if v2-CR1 240 has completed its data migration, the requested data can be directly provided to the newly upgraded client 1 262.

Sometimes, a v1-client may become a v2-client through client-server ring-version update protocol after communicating with a v2-CR, the v2-client may communicate with a v1-CR if the requested data is on a CR that has not been upgraded. When a v2-client (e.g., client 2 266) requests data (via communication 284) from a v1-CR (e.g., v1-CR3 224), the v1-CR3 224 may upgrade its KVDB to become v2-CR3 246 using client-server ring-version update protocol, as discussed above. The CR3 pair (224 and 244) may use CR-CR message-passing protocol, as discussed above, to start the data migration process. Thereafter, client 2 266 can retry by re-hashing its data request, and communicate with the newly upgraded v2-CR3 244 to obtain the requested data once the data migration is completed for the CR3 pair (224 and 244). In some embodiments, if the requested data has not been migrated, newly upgraded v2-CR3 244 may use the data-checking protocol (discussed earlier) to find and migrate the requested data first.

When a v2-client (e.g., client 2 266) requests data (via communication 286) from a v2-CR (e.g., v2-CR4 246) that is still performing data migration, v2-CR4 246 may use data-checking protocol, as discussed above, to find the requested data and respond to client 2 266, accordingly.

### 3. Network Partition

Sometimes, a network partition may occur before or during the ring-version upgrade process. A network partition may block a set of clients and servers of certain cells from communicating with remaining clients and servers to isolate problems (e.g., anomaly events) that occur in a cloud infrastructure, such as a system failure or malicious attack, and prevent the problems from spreading. The disclosed techniques may identify (or detect) and shut down a partition that does not have new cells and continue the ring-version upgrade process for the partitions that contain cells/servers (i.e., v2-CR) associated with a v2-ring that can communicate with cells/servers (i.e., v1-CR) associated with a v1-ring to migrate data. Once the downed partition has recovered and started again, the ring-version upgrade process can resume.

### C. Flowcharts

### 1. Non-Blocking and Eventually Consistent Hashing Process

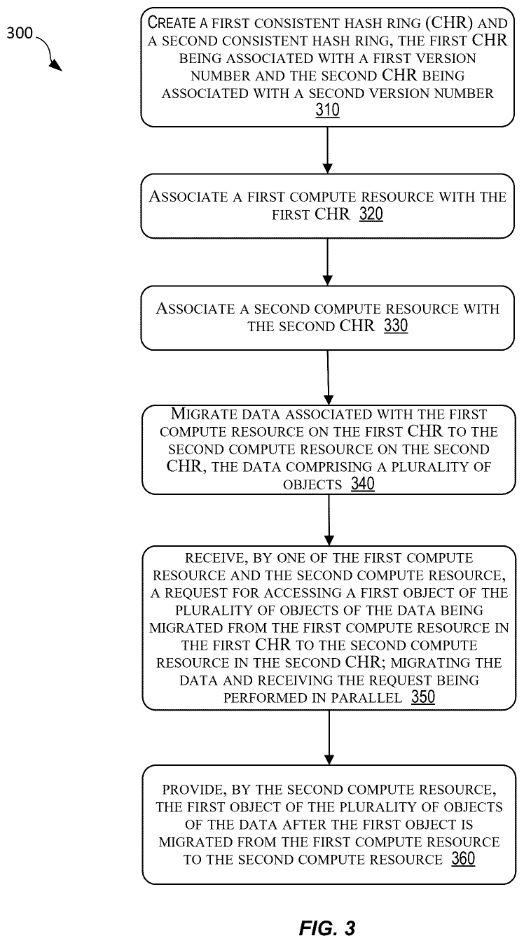

FIG. 3 is a flowchart illustrating a method for performing non-blocking and eventually consistent hashing, according to certain embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 3 may include a greater number or a lesser number of steps than those depicted in FIG. 3.

At block 310, a first consistent hash ring (CHR) and a second consistent hash ring are created. The first CHR may be associated with a first version number, and the second CHR may be associated with a second version number. For example, in FIG. 2, the version-1 CHR (i.e., v1-ring 202) is the existing CHR. When a customer of the CSP requests to add or remove cells, a version-2 CHR (i.e., v2-ring 204) may be created by duplicating the v1-ring to add or delete cells.

At block 320, a first compute resource may be associated with the first CHR. For example, in FIG. 2, a cell with one or more servers (i.e., v1-CR1 220) is associated with the v1-ring 202 by storing the v1 ring version in the KVDB for the cell 220.

At block 330, a second compute resource may be associated with the second CHR. For example, in FIG. 2, a cell with one or more servers (i.e., v2-CR1 240) is associated with the v2-ring 204 by storing the v2 ring version in the KVDB for the cell 240.

At block 340, data associated with the first compute resource in the first CHR is migrated to the second compute resource in the second CHR, where the data comprises a plurality of objects. For example, in FIG. 2, data (including data objects), stored in a storage (e.g., 140 of FIG. 1A) associated with v1-CR1 220 may be migrated from v1-CR1 220 to the storage associated with v2-CR1 240. The migration may involve updating the ring version number in the metadata of the data objects being migrated and recomputing the hash for the data objects.

At block 350, one of the first compute resource and the second compute resource may receive a request for accessing a first object of the plurality of objects of the data being migrated from the first compute resource in the first CHR to the second compute resource in the second CHR. Migrating the data and receiving the request can be performed in parallel. For example, in FIG. 2, during the version upgrade and data migration processes 290, a client (either a v1-client 260/264 or a v2-client 262/266) may request to access data from either a v1-CR or a v2-CR. As an illustration, v1-client 260 can request data from v1-CR2 222 via 282 communication or v2-CR1 240 via 280 communication. v2-client 266 can request data from v1-CR3 224 via 284 communication or v2-CR4 246 via 286 communication.

The request from the client, and the version upgrade and data migration process are non-blocking, and can be performed at the same time (or in parallel). In other words, the client request does not need to wait for the version upgrade and data migration processes 290 to complete. Additionally, two pairs of CRs (e.g., v1-CR1 & v2-CR1 pair, v1-CR2 & v2-CR2 pair) can perform their respective version upgrade and data migration processes independently and in parallel.

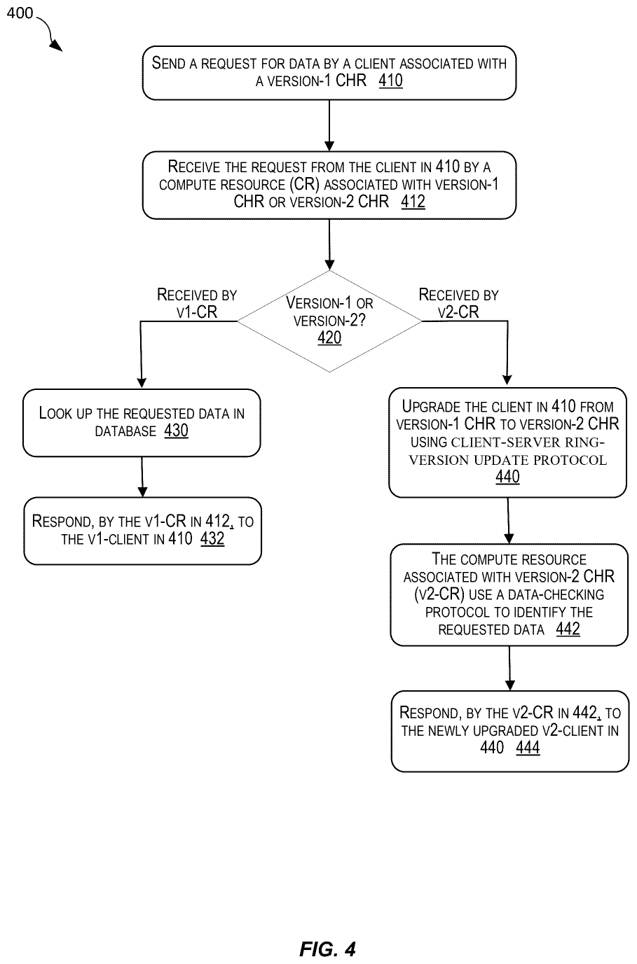

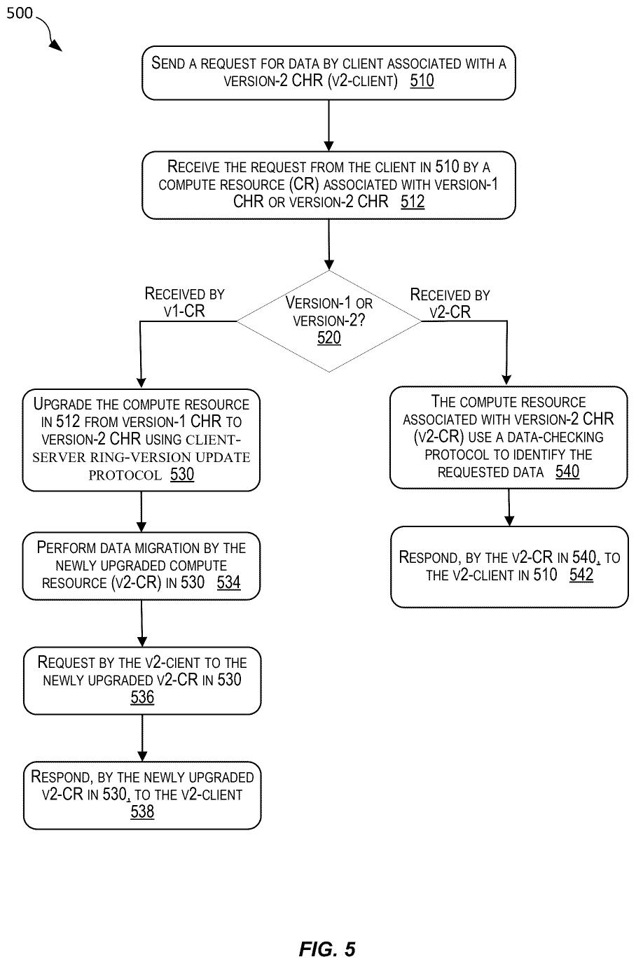

At block 360, the second compute resource may provide the first object of the plurality of objects of the data after the first object is migrated from the first compute resource to the second compute resource. For example, in FIG. 2, if client 1 (v1-client 1 260) requests data from v2-CR1 240, the requested data may be provided by v2-CR1 240 after the data has been identified and migrated, as described in FIG. 4 below. If client 2 (v2-client 2 266) initially requests data from v1-CR3 224 that has not been upgraded to v2-ring, the requested data may eventually be provided by v2-CR3 244 to v2-client 2 266 after the version upgrade for v1-CR3 224 and data migration processes 290, as described below in relation to FIG. 5.

### 2. Version-1 Client Request

FIG. 4 is a flowchart illustrating a method for fulfilling a request from a client associated with a version-1 CHR, according to certain embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 4 may include a greater number or a lesser number of steps than those depicted in FIG. 4.

At block 410, a request for data is sent by a client associated with a version-1 CHR. At block 412, the request from the client in 410 may be received by a compute resource (CR) associated with version-1 CHR or version-2 CHR. For example, in FIG. 2, v1-client 260 may send a request to a compute resource on a CHR, either v1-CR2 222 via communication 282, or v2-CR1 240 via communication 280. At block 420, if the request is received by a CR associated with version-1 CHR (e.g., v1-CR2 222), the process proceeds to block 430. If the request is received by a CR associated with version-2 CHR (e.g., v2-CR1 240), the process proceeds to block 440.

At block 430, v1-CR may look up the requested data in its associated database. For example, in FIG. 2, v1-CR2 222 may not have received notification from the cell manager about the new v2-ring. Thus, v1-CR2 222 may look up the requested data in its associated database.

At block 432, the v1-CR in 412 may respond to the v1-client in 410. For example, in FIG. 2, if the v1-CR identifies the requested data, it may respond and provide the requested data to v1-client 260. If the v1-CR cannot find the requested data, it may respond with no data found.

Returning to block 420, if the request is received by a CR associated with version-2 CHR (e.g., v2-CR1 240), the process proceeds to block 440. At block 440, the client in 410 is upgraded from version-1 CHR to version-2 CHR using client-server ring-version update protocol. For example, in FIG. 2, both v1-client 260 and v2-CR1 240 may exchange and compare their respective ring version numbers. Since v1-client 260 has a lower ring version (v1), v1-client 260 may update its ring version to v2, and become v2-client 262.

At block 442, the compute resource associated with version-2 CHR (v2-CR) uses a data-checking protocol to identify the requested data. For example, in FIG. 2, if v2-CR1 240 has not completed its data migration, it may use the requested data object name to look up its KVDB. If the object name does not match any data in the KVDB associated with v2-ring, v2-CR1 240 may send a request with the object name to v1-CR1 220 to check the availability in the KVDB associated with v1-ring. v1-CR1 220 may respond that no such object is found or migrate the requested data object to v2-CR1 240 if the requested data object is found.

At block 444, the v2-CR in 442 may respond to the newly upgraded v2-client in 440. For example, in FIG. 2, v2-CR2 242 may respond and provide the requested data to v2-client 262 after receiving the migrated data, or respond indicating the unavailability of the requested data after checking with v1-CR1 220. If v2-CR2 242 has completed its data migration, v2-CR2 242 can directly respond and provide the requested data to v2-client 262.

### 3. Version-2 Client Request

FIG. 5 is a flowchart illustrating a method for fulfilling a request from a client associated with a version-2 CHR, according to certain embodiments. The processing depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 5 may include a greater number or a lesser number of steps than those depicted in FIG. 5.

At block 510, a request for data is sent by a client associated with a version-2 CHR. At block 512, the request from the client in 510 may be received by a compute resource (CR) associated with version-1 CHR or version-2 CHR. For example, in FIG. 2, V2-client 266 may send a request to a compute resource on a CHR, either v1-CR3 224 via communication 284, or v2-CR4 246 via communication 286. At block 520, if the request is received by a CR associated with version-1 CHR (e.g., v1-CR3 224), the process proceeds to block 530. If the request is received by a CR associated with version-2 CHR (e.g., v2-CR4 246), the process proceeds to block 540.

At block 530, the compute resource in 512 may be upgraded from version-1 CHR to version-2 CHR using client-server ring-version update protocol. For example, in FIG. 2, both v2-client 266 and v1-CR3 224 may exchange and compare their respective ring version numbers. Since v1-CR3 224 has lower ring version (v1), v1-CR3 224 may update its ring version to v2, and become v2-CR3 244. In some embodiments, v1-CR3 224 may notify v2-client 266 to send its request again later to v2-CR3 244 after v1-CR3's upgrade has completed because v1-CR3 224 may be deleted after the upgrade and data migration. In other embodiments, v1-CR3 224 may pass the client's request to v2-CR3 244 during its upgrade and data migration processes.

At block 534, data migration may be performed by the newly upgraded compute resource (v2-CR). For example, in FIG. 2, after v1-CR3 224 becomes v2-CR3 244 by updating its ring version number from v1 to v2, v2-CR3 244 can use CR-CR message-passing protocol to start the data migration process 290 by communicating with v1-CR3 224 to copy identified data objects for migration including the requested data object to storage associated with v2-CR3 244 through the re-sharding process.

At block 536, the v2-client may send request to the newly upgraded v2-CR in 530. For example, in FIG. 2, v2-client 266 can retry by re-hashing its data request and communicating with the newly upgraded v2-CR3 244. At block 538, the newly upgraded v2-CR in 530 may respond to the v2-client. For example, in FIG. 2, the newly upgraded v2-CR3 244 may use the data-checking protocol (discussed earlier) to find and migrate the requested data first, then respond and provide the requested data to v2-client 266 if the requested data is identified.

Returning to block 520, if the request is received by a CR associated with version-2 CHR (e.g., v2-CR4 246), the process proceeds to block 540. At block 540, the compute resource associated with version-2 CHR (v2-CR) uses a data-checking protocol to identify the requested data. For example, in FIG. 2, if v2-CR4 246 has not completed its data migration, it may use the requested data object name to look up its KVDB. If the object name does not match any data in the KVDB associated with v2-ring, v2-CR4 246 may send a request with the object name to v1-CR4 226 to check the availability in the KVDB associated with v1-ring. v1-CR4 226 may respond that no such object is found or migrate the requested data object to v2-CR4 246 if the requested data object is found.

At block 542, the v2-CR in 540 may respond to the v2-client in 510. For example, in FIG. 2, v2-CR4 246 may respond and provide the requested data to v2-client 266 after receiving the migrated data, or respond indicating the unavailability of the requested data after checking with v1-CR4 226. If v2-CR4 246 has completed its data migration, v2-CR4 246 can directly respond and provide the requested data to v2-client 266.

### Example Cloud Service Provider Infrastructure (CSPI) Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

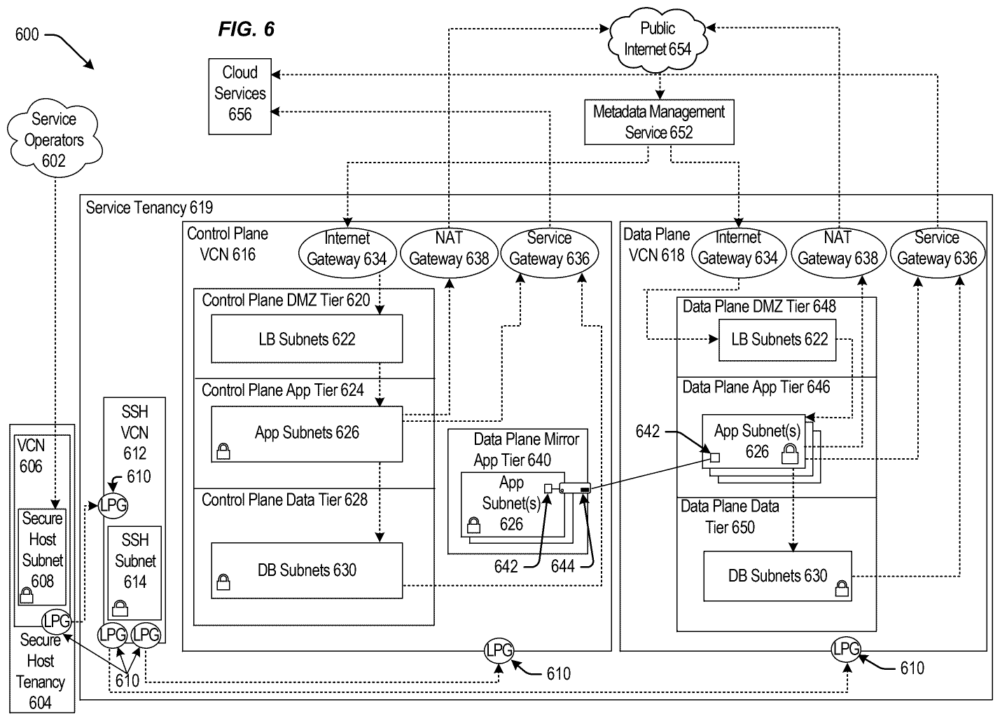

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

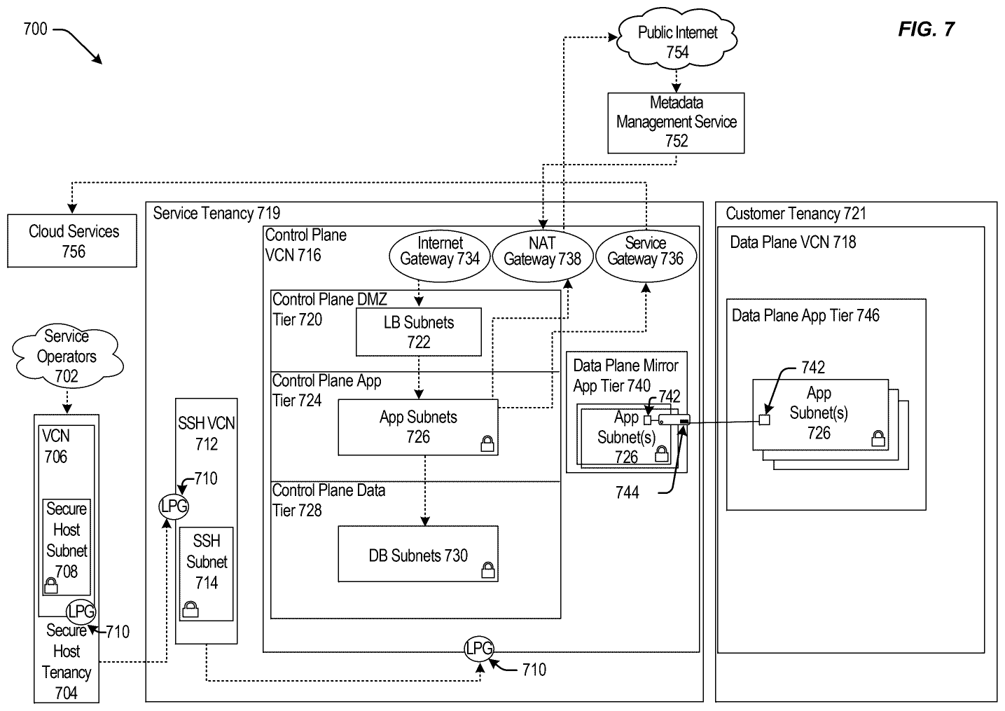

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

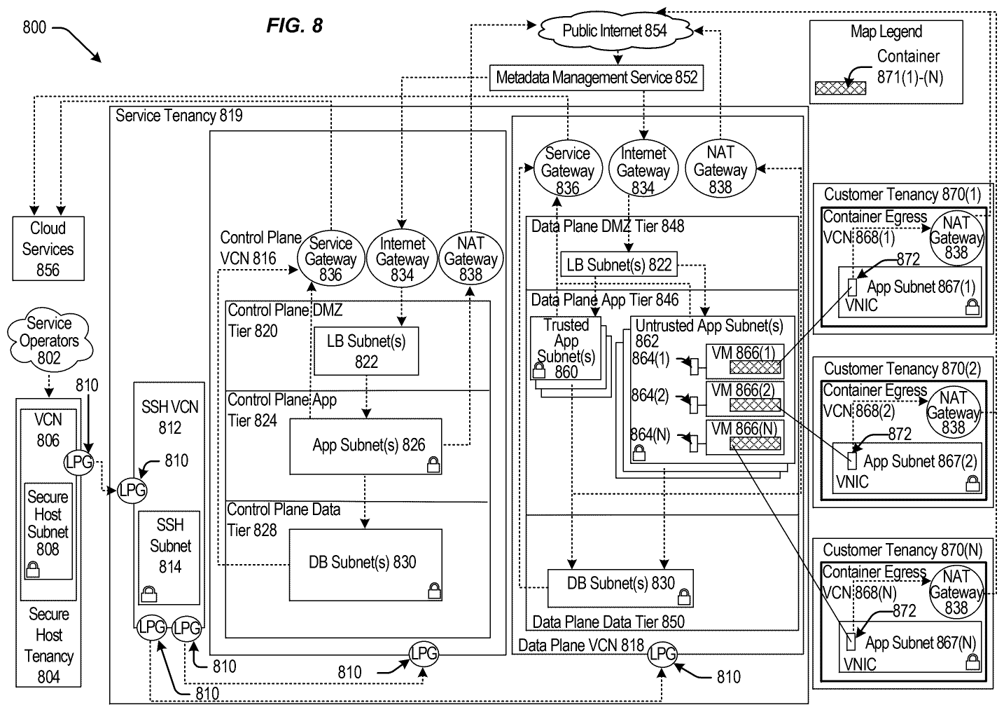

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

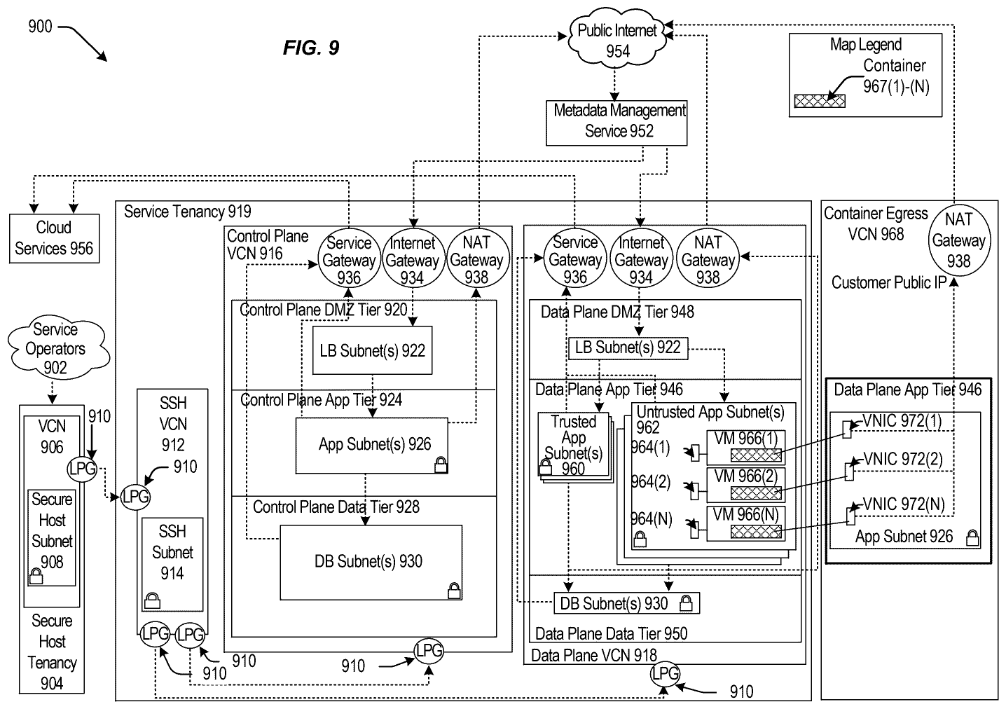

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

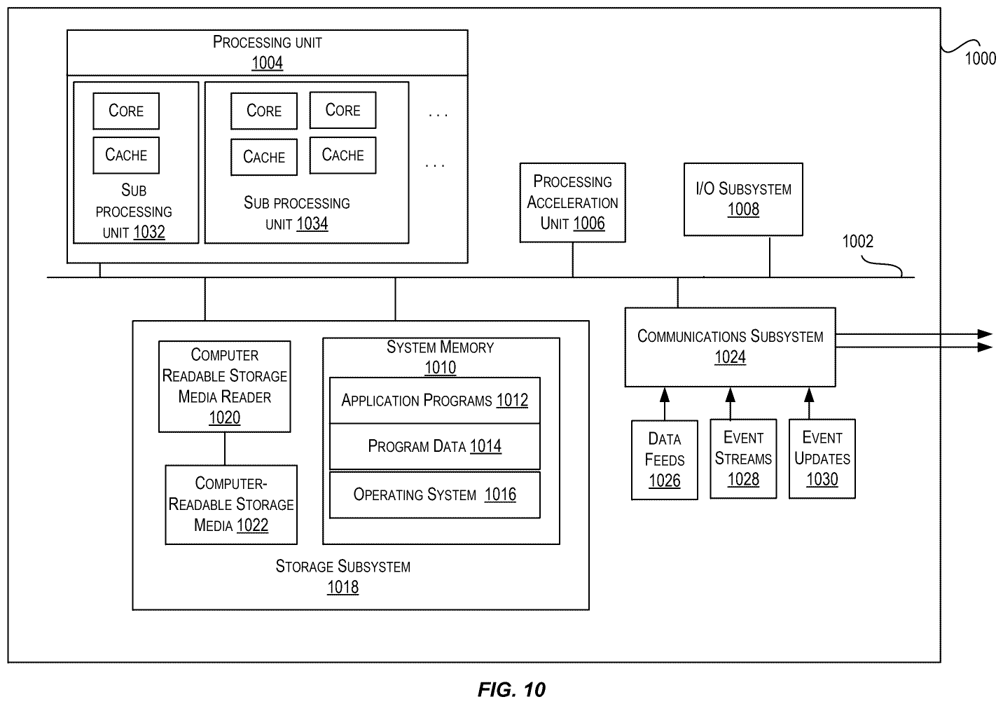

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
creating, by a computing system, a first consistent hash ring (CHR) and a second consistent hash ring, the first CHR being associated with a first version number, the second CHR being associated with a second version number;
associating, by the computing system, a first compute resource with the first CHR by linking the first version number to the first compute resource;
associating, by the computing system, a second compute resource with the second CHR by linking the second version number to the second compute resource;
migrating, by the computing system, data associated with the first compute resource in the first CHR to the second compute resource in the second CHR, the data comprising a plurality of objects;
receiving, by one of the first compute resource and the second compute resource of the computing system, a request for accessing a first object of the plurality of objects of the data being migrated from the first compute resource in the first CHR to the second compute resource in the second CHR; and
providing, by the second compute resource of the computing system, the first object of the plurality of objects of the data after the first object is migrated from the first compute resource to the second compute resource.

2. The method of claim 1,
wherein the second compute resource is a duplicate of the first compute resource;
wherein the second version number is higher than the first version number;
wherein linking the first version number to the first compute resource comprises storing the first version number in a database for the first compute resource; and
wherein migrating the data and receiving the request are performed in parallel.

3. The method of claim 1, wherein migrating data associated with the first compute resource to the second compute resource comprising:
communicating by the second compute resource to the first compute resource;
identifying a set of objects of the plurality of objects of the data;
updating metadata of each of the set of objects with the second version number; and
copying the set of objects from a storage associated with the first compute resource to a storage associated with the second compute resource.

4. The method of claim 1, wherein the request for accessing the first object of the plurality of objects of the data is originated by a first requester associated with the first CHR, and wherein the first requester is linked to the first version number.

5. The method of claim 4, wherein one of the first compute resource and the second compute resource receiving the request is the second compute resource.

6. The method of claim 5, further comprising:
checking, by the second compute resource, the availability of the first object in a storage for the second compute resource;
in response to the checking that the first object is not available, communicating, by the second compute resource, with the first compute resource;
checking, by the first compute resource, the availability of the first object in a storage for the first compute resource; and
responding from the first compute resource to the second compute resource a result of the checking.

7. The method of claim 5, further comprising:
changing the association of the first requester from the first CHR to the second CHR; and
providing the first object of the plurality of objects of the data by the second compute resource to the first requester after the first requester's change of the association to the second CHR.

8. The method of claim 5, wherein changing the association of the first requester from the first CHR to the second CHR comprises replacing the first version number linked to the first requester with the second version number.

9. The method of claim 1,
wherein the request for accessing the first object of the plurality of objects of the data is originated by a second requester associated with the second CHR;
wherein the second requester is linked to the second version number; and
wherein one of the first compute resource and the second compute resource receiving the request is the first compute resource.

10. The method of claim 9, further comprising:
notifying the second requester to send the request for accessing the first object of the plurality of objects of the data to the second compute resource,
continuing to migrate the data associated with the first compute resource in the first CHR to the second compute resource in the second CHR;
sending, by the second requester, another request for accessing the first object of the plurality of objects of the data.

11. The method of claim 1, wherein the first object cannot be accessed until it has been migrated to the second compute resource.

12. The method of claim 1, further comprising:
associating a third compute resource with the first CHR by linking the first version number to the third compute resource;
associating a fourth compute resource with the second CHR by linking the second version number to the fourth compute resource; and
migrating data associated with the third compute resource in the first CHR to the fourth compute resource in the second CHR;
wherein migrating data associated with the first compute resource to the second compute resource is performed independently of migrating data associated with the third compute resource to the fourth compute resource.

13. A non-transitory computer-readable medium storing computer-executable instructions that, when executed by one or more processors of a computing system, cause the one or more processors to perform operations comprising:
creating, by a computing system, a first consistent hash ring (CHR) and a second consistent hash ring, the first CHR being associated with a first version number and the second CHR being associated with a second version number;
associating, by the computing system, a first compute resource with the first CHR by linking the first version number to the first compute resource;
associating, by the computing system, a second compute resource with the second CHR by linking the second version number to the second compute resource, the second compute resource being a duplicate of the first compute resource;
migrating, by the computing system, data associated with the first compute resource in the first CHR to the second compute resource in the second CHR, the data comprising a plurality of objects;
receiving, by one of the first compute resource and the second compute resource of the computing system, a request for accessing a first object of the plurality of objects of the data being migrated from the first compute resource in the first CHR to the second compute resource in the second CHR; and
providing, by the second compute resource of the computing system, the first object of the plurality of objects of the data after the first object is migrated from the first compute resource to the second compute resource.

14. The non-transitory computer-readable medium of claim 13, wherein migrating data associated with the first compute resource to the second compute resource comprising:
communicating by the second compute resource to the first compute resource;
identifying a set of objects of the plurality of objects of the data;
updating metadata of each of the set of objects with the second version number; and
copying the set of objects from a storage associated with the first compute resource to a storage associated with the second compute resource.

15. The non-transitory computer-readable medium of claim 13, wherein the request for accessing the first object of the plurality of objects of the data is originated by a first requester associated with the first CHR, and wherein one of the first compute resource and the second compute resource receiving the request is the second compute resource.

16. The non-transitory computer-readable medium of claim 13, wherein the request for accessing the first object of the plurality of objects of the data is originated by a second requester associated with the second CHR, and wherein one of the first compute resource and the second compute resource receiving the request is the first compute resource.

17. A computing system, comprising:
one or more processors; and
one or more non-transitory computer readable media storing computer-executable instructions that, when executed by the one or more processors of the computing system, cause the computing system to:
create, by the computing system, a first consistent hash ring (CHR) and a second consistent hash ring, the first CHR being associated with a first version number and the second CHR being associated with a second version number;
associate, by the computing system, a first compute resource with the first CHR by linking the first version number to the first compute resource;
associate, by the computing system, a second compute resource with the second CHR by linking the second version number to the second compute resource, the second compute resource being a duplicate of the first compute resource;
migrate, by the computing system, data associated with the first compute resource in the first CHR to the second compute resource in the second CHR, the data comprising a plurality of objects;
receive, by one of the first compute resource and the second compute resource of the computing system, a request for accessing a first object of the plurality of objects of the data being migrated from the first compute resource in the first CHR to the second compute resource in the second CHR; and
providing, by the second compute resource of the computing system, the first object of the plurality of objects of the data after the first object is migrated from the first compute resource to the second compute resource.

18. The computing system of claim 17, wherein migrating data associated with the first compute resource to the second compute resource comprising:
communicating by the second compute resource to the first compute resource;
identifying a set of objects of the plurality of objects of the data;
updating metadata of each of the set of objects with the second version number; and
copying the set of objects from a storage associated with the first compute resource to a storage associated with the second compute resource.

19. The computing system of claim 17, wherein the request for accessing the first object of the plurality of objects of the data is originated by a first requester associated with the first CHR, and wherein one of the first compute resource and the second compute resource receiving the request is the second compute resource.

20. The computing system of claim 17, wherein the request for accessing the first object of the plurality of objects of the data is originated by a second requester associated with the second CHR, and wherein one of the first compute resource and the second compute resource receiving the request is the first compute resource.
